(19) United States
(12) Patent Application Publication
(10) Pub. No.: US 2025/0053705 A1
(43) Pub. Date: Feb. 13, 2025

(54) METHOD AND SYSTEM EMPLOYING BOUNDARY ELEMENT METHOD WITH ADAPTIVE ORDER FOR ACOUSTIC EMISSION AND SCATTERING ANALYSIS

(71) Applicant: Siemens Industry Software NV, Leuven (BE)

(72) Inventors: Hadrien Beriot, Le Vesinet (FR); Onur Atak, Cambridge (GB); Yue Li, Leuven (BE)

(21) Appl. No.: 18/718,033

(22) PCT Filed: Jun. 14, 2022
(86) PCT No.: PCT/EP2022/066183

§ 371 Date: Jun. 8, 2024

(30) Foreign Application Priority Data
Dec. 8, 2021 (EP) 21213215.3
Dec. 10, 2021 (EP) 21213810.1

(51) Int. Cl. G06F 30/23; G06F 111/10; G06F 113/28

(52) U.S. Cl. CPC G06F 30/23; G06F 2111/10; G06F 2113/28

(57) ABSTRACT

The invention relates to a computer-implemented method computer product, computer-readable medium, and system for determining acoustic parameters of an object's (OBJ) emission and/or scattering within a predetermined frequency range (FRG), by applying Boundary Element Method (BEM) to the object, comprising splitting said object's (OBJ) surface into surface elements (ESF) and assigning boundary conditions (BCD) to said surface elements (ESF), further comprising •Providing polynomial shape functions (SFC) over each of said elements (ESF) for mapping geometry and acoustic parameters to said elements (ESF), wherein for each surface element (ESF) the order (SFO) of said shape functions (SFC) is determined by an adaptivity module (ADM), •Assembling the elements (ESF) of said surface by recombining the shape functions (SFC) obtaining a system matrix (SMX), •Solving said system matrix (SMX), •Determining said acoustic parameters (PRT) from said shape functions (SFC).

The invention relates to a computer-implemented method for determining acoustic parameters of an object's emission and/or scattering within a predetermined frequency range, comprising the steps:
(a) Defining said object,
(b) Defining a system containing said object,
(c) Providing boundary conditions for said system including defining a sound source,
(d) Applying Boundary Element Method to said system comprising splitting said object's surface into surface elements and assigning said boundary conditions to said surface elements.

### FIELD OF THE INVENTION

Computational Acoustics is an ever-evolving field, where the customer requirements for designing the sound of products are both driven by user demands for higher quality sounds but also by legislative restrictions that puts more and more stricter limits on the allowed noise in communal places, e.g. the pass-by-noise requirements for automotive industry, landing noise for aerospace etc.

### BACKGROUND OF THE INVENTION

Acoustic engineering deals with sound and vibration. Acoustical engineers are typically concerned with analysis and control of sound as well as with the supporting tools to design objects with regard to sound emission or scattering.

One frequent goal is the reduction of unwanted noise. Such noise may be reduced by redesigning of sound sources or scattering objects and implementing sound absorbers.

Today's acoustic engineering requires effective tools to improve sound properties of such objects. The invention deals with the improvement of determining acoustic parameters of an object's emission which is fundamental for above illustrated improvements.

Acoustic engineers use various Computer Aided Engineering [CAE] methods to find the best design for their products.

In general, a sound is a mechanical wave that is an oscillation of pressure transmitted through a medium. The oscillation is characterized by frequencies. Sound that is perceptible by hearing by humans has frequencies ranging from about 20 Hz to 20,000 Hz. A sound field in a given system is defined by sound pressure and acoustic velocity at all points of the system.

The application of a boundary element method suitable for smaller and medium problems is known from XIE XIANG ET AL: “An adaptive model order reduction method for boundary element-based multi-frequency acoustic wave problems”, COMPUTER METHODS IN APPLIED MECHANICS AND ENGINEERING, NORTH-HOLLAND, AMSTERDAM, NL, vol. 373, 7 Nov. 2020 (2020-11-07), XP086401454, ISSN: 0045-7825, DO1: 10.1016/J. CMA. 2020.113532.

The modelling of a multi-domain acoustic problem using boundary element method suitable for smaller and medium problems is known from CREMERS L ET AL: “A variable order infinite element for multi-domain boundary element modelling of acoustic radiation and scattering”, APPLIED ACOUSTICS, ELSEVIER PUBLISHING, GB, vol. 59, no. 3, 1 Mar. 2000 (2000-03-01), pages 185-220, XP002297182, ISSN: 0003-682X, DOI: 10.1016/S0003-682X(99)00029-8.

Some aspects related to the invention may be better understood from the following list of publications being referenced further below:
[1] Fischer, M., Gauger, U., & Gaul, L. (2004). A multipole Galerkin boundary element method for acoustics. Engineering analysis with boundary elements, 28 (2), 155-162.
[2] Hackbusch, W., & Khoromskij, B. N. (2000). A Sparse H-Matrix Arithmetic. Computing, 64 (1), 21-47.
[3] Stephan, E. P., & Suri, M. (1989). On the convergence of the p-version of the boundary element Galerkin method. Mathematics of computation, 52 (185), 31-48.
[4] Feischl, M., Führer, T., Heuer, N., Karkulik, M., & Praetorius, D. (2015). Adaptive boundary element methods. Archives of Computational Methods in Engineering, 22 (3), 309-389.
[5] Keuchel, S., Vater, K., & Estorff, O. V. (2017). hp Fast multipole boundary element method for 3D acoustics. International Journal for Numerical Methods in Engineering, 110 (9), 842-861.
[6] Babuška, I., & Suri, M. (1994). The p and h-p versions of the finite element method, basic principles and properties. SIAM review, 36 (4), 578-632.
[7] EP2816332B1 deals with a method for modeling the sound emission and propagation of systems over a wide frequency range.
[8] Sauter, S. A., & Schwab, C. (2010). Boundary element methods. In Boundary Element Methods (pp. 183-287). Springer, Berlin, Heidelberg.
[9] H. Bériot, A. Prinn, G. Gabard, Efficient implementation of high-order finite elements for helmholtz problems, International Journal for Numerical Methods in Engineering 106 (2016) 213-240.
[10] V. Rokhlin, Diagonal forms of translation operators for the Helmholtz equation in three dimensions, Applied and Computational Harmonic Analysis 1 (1993) 82-93.
[11] R. Coifman, V. Rokhlin, S. Wandzura, The fast multipole method for the wave equation: A pedestrian prescrip-tion, IEEE Antennas and Propagation Magazine 35 (1993) 7-12.
[12] J. Rahola, Diagonal forms of the translation operators in the fast multipole algorithm for scattering problems, BIT Numerical Mathematics 36 (1996) 333-358

The boundary element method (BEM), also referred to as boundary integral equation method, is a well-known numerical method in many engineering applications, such as electromagnetics, acoustics, fluid mechanics, fracture mechanics etc. The unique advantage of BEM over volumetric numerical methods, e.g., finite element method [FEM], finite volume method, is that BEM reduces the dimensionality of the problem by one. It only requires a two-dimensional discretization for a three-dimensional problem. BEM only requires meshing of the boundaries of the geometry, and it natively supports acoustic problems with unbounded domains (radiation of sound in free spaces). This advantage brings great value to modern computational-aided engineering applications considering that the volume mesh generation process can impose a significant manual labor cost in practice. The meshing effort is limited, and the system matrices are smaller. The unbounded domains are common for acoustic applications. BEM is inherently convenient in computing such cases as the Kirchhoff-Helmholtz integral equation satisfies the Sommerfeld radiation condition.

Disadvantages of the BEM over the FEM are that the BEM matrices are fully populated, with complex and frequency-dependent coefficients, which deteriorate the efficiency of the solution. Furthermore, singularities may arise in the solution.

One popular example for the application of BEM is the prediction the sound radiation of a tire from the knowledge of the tire geometry and the surface velocity of the tire.

Acoustic simulations are typically executed in frequency domain and the users need to solve the problem for many frequencies to understand the system characteristics correctly. The dynamics of the problem become more challenging as the frequency raises, so in typical applications, the numerical models also need to be refined accordingly. This refinement of the model has been classically done by remeshing the geometry for the higher frequencies by using, e.g., 6 linear elements per wavelength criteria.

Classical BEM formulations have two main problems for this process.

Firstly, the BEM becomes prohibitively expensive for very large models.

Secondly, the users have to make a compromise between the hands-on time versus computational time. Computer resources may be saved using customized meshes for the respective problem—ideally, multiple discretizations of the same problem are needed to have an efficient frequency sweep scenario. On the other hand, remeshing is very time consuming—as it needs hands on time from the users to setup their models multiple times. Because of this, it is most often that users use a single mesh for the full frequency range, which means the computations are unnecessarily costly for the lower frequencies since lower frequencies tolerate a lower mesh density and are still sufficiently accurate. This trade-off between hands-on time versus high computational time poses an ongoing challenge for the users.

An additional ongoing problem in the industry is also about the type of discretizations that computer aided engineering [CAE] engineers receive. In an ideal workflow, a computer aided design [CAD] info is available and a clean and homogenous mesh can be generated from it. The source CAD files may not be available, the source exchange files can be dirty, and even with the best meshing technologies, creating perfect homogenous meshes is not always possible for complex geometries. The resulting non-homogenous discretizations from such scenarios either lead to poor accuracy (if used for high frequencies) or extra computation time (if used for low frequencies).

Three main points may summarize the potential disadvantages in today's BEM solvers;
1. High computational cost for large models,
2. Requirement to provide multiple discretizations to solve problems in a wide frequency range,
3. Non-ideal discretizations that pollute the accuracy of the solutions.

Regarding the first issue of high computational cost for large models two main families of approaches have been made to solve the high-cost problem of BEM.

The first family of approaches addresses the poor scalability of the BEM method. The two most established ones in this family are the Fast Multipole BEM [1] and H-Matrix [2] methods. Siemens offers a software product in the mechatronic engineering field named Simcenter 3D which is a commercial simulation software for the modeling and analysis of multi-domain systems which software offers both methods. These methods are based on approximating far field element interactions, and they work well for ultra-large problems. They modify the scaling of the method, i.e., they become more and more efficient as compared to the classical BEM formulations with growing problem size.

The second family of approaches focuses on the use of efficient basis functions.

It has been shown that the convergence rate of low order elements is not ideal for BEM [3]. Using high order shape functions leads to much better convergence rates, therefore creating more compact models. Although the advantage of using high order elements is known theoretically, there has been a lack of recipe in literature for the deployment of such elements to be automatically used for general shapes and problems.

Acceleration via the first or second family of approaches are not mutually exclusive. A high order BEM model can also be accelerated via Fast Multipole BEM. The focus of the current invention is to address the high computational cost via exploiting high order shape functions, while also accelerating the method via multipole expansions.

The requirement to provide multiple discretizations to solve problems in a wide frequency range may be addressed by a class of methods in literature that automatically refines both the discretization and the field order of the elements to address this issue. These methods are called h-p refinement methods and they exist both for FEM and BEM [4-6]. They typically use a-posteriori error indicators to find the high error regions and they iteratively refine the mesh and/or element order around those regions. While it is shown that convergence rates of these methods are impressive, they are not easily applicable to geometries with industrial complexity. Automatic local refinement via a loop over the CAD discretization is very difficult to achieve on an industrial scale and the many solver iterations that are required to find the optimal discretization can very quickly become prohibitive, cancelling out the computational benefits of these methods.

Because of this, a-priori error estimators are preferred for the industrial problems, that aim to find the optimal discretization by running a single simulation per frequency. In addition, p-refinement is preferred over h-p refinements, due to the lack of robustness of the latter for industrial problems as explained above.

The Adaptive Order Finite Element Method [FEMAO] is a method that has been developed by the applicants in recent years [7]. It is an analysis to find potential sources of defects in products or processes, to recognize their significance and to evaluate them. It uses an a-priori error estimator and p-refinement for acoustic problems and addresses all the outlined problems above. However, there exists no such method for BEM.

Regarding non-ideal discretizations that may diminish the accuracy of the solutions, there are various BEM approaches that aim to adapt the discretization of the problem, but they have not been applicable to problems of industrial complexity. What is especially lacking is a method that can solve the acoustic problems with extremely non-homogeneous boundary meshes. These are meshes with large differences between low densities and high densities e.g. due to the geometry of the specimen. Being able to solve such boundary discretizations can bring many advantages; both from computational efficiency point of view, but also from a process point of view. It may be possible to even use boundary representation [BREP] geometries (e.g. tessellation), which are typically very anisotropic and non-homogenous, directly in the solver. Such an application would mean to establish a direct CAD-CEA connection, that is lacking in today's conventional workflows

### SUMMARY OF THE INVENTION

It is one object of the invention to overcome or at least mitigate the problems identified with the prior art as explained above.

It is an object of the invention to reduce computational costs for large models.

It is another object of the invention to preferably provide multiple discretizations to solve problems in a wide frequency range.

It is another object of the invention to avoid non-ideal discretizations that may reduce the accuracy of the solutions.

The object of the invention is achieved by the independent claims. The dependent claims describe advantageous developments and modifications of the invention.

In accordance with the invention there is provided a solution for the above-described problems by the incipiently defined method characterized by the Boundary Element Method including:
(e) Providing polynomial shape functions over each of said elements for mapping geometry and acoustic parameters to said elements, wherein for each surface element determining the order of said shape functions by an adaptivity module,
(f) Assembling the elements of said surface by recombing the shape functions obtaining a system matrix,
(g) Solving said system matrix,
(h) Determining said acoustic parameters from said shape functions.

The combination of these steps creates a very powerful and efficient BEM solver. The method according to the invention may also be referred to as a Boundary Element Method with Adaptive Order [BEMAO].

Herein the step (e) of providing polynomial shape functions may preferably be understood as constructing piecewise polynomial approximations based on shape functions. These polynomial approximations are then constructed over each of the elements to approximate the field of interest (this may be the acoustic pressure or acoustic velocity). The contributions of the shape functions to the whole system are the unknowns of the problem to be approximated.

These discrete unknowns are linked in each individual element by a series of equations containing time-consuming numerical quadrature operations. All of these local contributions (the elementary matrices) are then recombined into a global system of equations (the system matrix). This entire process is called assembling the system as defined by step (f) as the assembling of the elements of said surface by recombing the shape functions obtaining a system matrix.

One preferred embodiment provides said shape functions as high order shape functions. High order shape functions are polynomials of at least order two. Using the high order shape functions compresses the degrees of freedom (Dof) of the system. From studies, it was found that for achieving the same accuracy, maybe an error of 1%, the order 1 model required ˜60k Dof and 85 minutes calculation time, while the order 5 model required ˜5k Dof and the calculation was finished only in 1 min.

According to another preferred embodiment step (e) may comprise determining the order of said shape functions for each surface element, by an adaptivity module receiving as an input at least:
said required accuracy
the surface element's dimensions, and
the frequency range and returning as an output said shape function order.

Generally, said surface elements may be characterized by a dominant direction respectively a specific dimensional relation. In a preferred embodiment such shape and direction property may be considered when determining the order of said shape functions. Preferably determining the order of said shape functions may comprise:
determining for said surface elements a shape-and-direction-property, wherein said property may comprise data about dimensional relations including directional information,
providing said shape and direction property as additional input to step (f).

This feature will enable to adjust the shape function order more adequately to the surface element's shape.

One preferred embodiment particularly considers acoustic applications by allowing said boundary conditions defined in step (d) to include boundary conditions relating to said object and/or include boundary conditions referring to limits of said system and/or said system at least partially being defined as an unbounded domain.

Another preferred embodiment enables to provide boundary conditions relating to said object including vibration characteristics of said sound source resulting from excitation of said object applied in at least one excitation frequency. The object may be or may comprise the sound source, but the sound source can be at a different position-separate from the object, too.

Another preferred embodiment enables to provide the object's surface geometry by providing an object's surface tessellation. Such format may easily be provided from any CAD environment.

The adaptive approach to Boundary Element Method according to the invention allows to compute a frequency sweep, guaranteeing both computational efficiency and bounded accuracy for any input mesh. This enables to include highly heterogenous Brep geometries coming from computer graphics (i.e., tessellations) which are normally not suitable for BEM Analysis.

According to a preferred embodiment of the invention step (g) is performed by using Sauter-Schwab quadrature rules. These quadrature rules use various advanced coordinate transformations and provide Jacobians that cancel out the singularities of the kernel. The main advantage of using these rules is that they allow integration on linear and quadratic geometric elements and for both triangular and quadrilateral shapes.

According to a preferred embodiment of the invention in step (e) said sound source's geometry may be split in surface elements by applying a triangular or quadrilateral or hybrid mesh of surface elements. In particular a mesh comprising elements of at least one of the types Tria3, Tria6, Quad4, Quad8 may be applied. These different mesh types enable best model adjustment to the underlying problem.

According to a preferred embodiment of the invention in step (e) said shape functions may comprise:
geometry shape functions mapping quadrature points of said elements to a surface position and
field shape functions that interpolate at least one acoustic parameter based on input frequency. Said acoustic parameter may be pressure and/or sound velocity.

According to further preferred embodiment of the invention may use a non-isoparametric approach in step (e). Using a non-isoparametric approach means that said polynomial shape functions for approximating parameters are provided non-isoparametric or, in other words: the shape functions used for representing the geometry and shape functions used to interpolate the field variables are separated. This separation allows to use a single geometry discretization to cover a wide frequency range.

Generally field variables may be at least one of acoustic pressure, acoustic velocity, speed of sound, wavelength, frequencies, and amplitudes of such quantities, etc. In the most common case field variables of the acoustic equation are pressure and/or velocity.

In the context of this document the term ‘kernel’ is to be understood as a term of linear algebra if not indicated differently. As BEM generally comprises a linear map between two (vector) spaces the kernel of a linear map BEM, also known as the null-space, is the linear subspace of the domain of the map which is mapped to the zero vector.

According to another preferred embodiment of the invention may use a solver configured to adapt the interpolation functions of said field variables automatically.

According to still another preferred embodiment of the invention an adaptivity module may determine the order of said shape functions for each surface element by iteratively applying an a-priori error estimation from
the surface element's dimensions, and
the frequency range, and
the shape function order
   until the error estimate corresponds to the required accuracy. An additional input for the a-priori error estimation may be the above explained shape-and-direction-property.

According to still another preferred embodiment of the invention the system matrix assembly process of step (g) is accelerated by using Fast Multipole Approximations. The fast multipole method (FMM) is a well-known numerical technique. The FMM speeds up the calculation of interaction of far away particles. The system Green's function is expanded by applying a multipole expansion allowing to group sources that lie close together and to treat them as a single source.

Preferably these Fast Multipole Approximations (FMM) are explicitly multiplied with each other and form the system matrix in a dense format, which allows the execution of step (m) with a direct matrix solver.

Most preferably the Fast Multipole Approximations may be stored in a matrix-vector format, which allows the efficient execution of step (h) with an iterative matrix solver

In BEM, all the boundary elements interact with each other, resulting in an O(N)\hat{ }2 complexity for the standard assembly procedure. The invention fully exploits the power of high order shape functions and compresses the size of the model, therefore reducing the matrix solving time of the dense system substantially. On the other hand, using high order shape functions still requires a costly system assembly step.

One property of BEM that can be exploited by the invention is that the contribution from the far-away elements become smaller with increasing distance. As such, various approximation techniques can be used to accelerate the assembly of the system. A multi-level fast multipole based acceleration may be used for system assembly. This algorithm changes the complexity of the assembly from O(N)\hat{ }2 to O(N*Log(N)\hat{ }2). By preferably using the multipole approximations in the far field, the error is also robustly controlled.

Significantly shortening the assembly time complements the improved system solving time resulting from high orders and results in a very powerful method.

Preferably special quadrature rules may be applied to deal with these singularities to obtain sufficient accuracy of the results.

According to a preferred embodiment, the quadrature rules to be applied for the purpose of the invention may be the ones developed by Sauter et. al [8]. Under the regime of this method a number of quadrature points and weights are defined. Sauter et. al [8] proposes various advanced coordinate transformations and provides Jacobians that cancel out the singularities of the kernel. Jacobians here refers to the Jacobian matrix which is the matrix of all first-order partial derivatives of a vector-valued function of several variables. One essential advantage of using the quadrature rules of Sauter et. al [8] is that they allow integration on linear and quadratic geometric elements and for both triangular and quadrilateral shapes. The application of the quadrature rules of Sauter et. al [8] enables the support of meshes with Tria3, Tria6, Quad4 and Quad8 elements, as well as hybrid meshes that are composed of both triangular and quadrilateral elements.

The use of the Sauter quadrature rules beneficially enables to implement high order shape functions.

Conventionally, there is no analytical way to define the required quadrature orders for the BEM kernel.

According to a preferred embodiment automatic shape function order assignment as used by the invention also may comprise an automatic quadrature order assignment for these elements. A good balance may be beneficial assigning the automatic shape function order and automatic quadrature order. To avoid inaccuracies the assignment may not be too low order. To avoid excessive computational resource consumption the assignments may not be overly accurate.

The automatically selected order of the quadrature rules ensures that the quadrature error never exceeds the interpolation error imposed by the order of the shape functions, but also that they are not overly expensive to calculate.

The BEM integrals are surface integrals for a 3D problem. Said surface integrals comprise:
a) shape functions to map the quadrature points to the surface (via the Jacobian of the integral) and
b) shape functions that interpolate the primary unknowns of the system.

One possibility is to use the same shape functions for both. This Isoparametric approach simplifies the implementation of the method and it also helps to balance the error between geometry and interpolation. In a typical acoustic application, discretizing the geometry using six linear elements per wavelength may provide a good engineering accuracy using this approach.

According to a preferred embodiment of the invention a non-isoparametric approach may be applied. The order of the geometry and interpolation shape functions are separated. Further preferred the geometry definition may be kept the same in a frequency sweep, while the orders of the interpolation shape functions may be automatically adjusted to the frequency per element.

Doing so, the geometry does not need to be re-discretized per frequency region. The effort for remeshing and setting up multiple discretizations of the same model may be saved this way. This improvement saves precious hands-on time from the CAE engineers. An alternative traditional approach would be to use the same mesh designed for the highest frequency, for the full frequency spectrum. This latter approach leads to excessive calculation times. The preferred embodiment of the invention avoids these both drawbacks and enables sufficient accuracy.

Due to the ‘per element per frequency’ adaptivity rule, the requirement for a homogeneous mesh is completely removed for the invention.

An ideal mesh used with a method according to the invention should be non-homogeneous. The geometrical details should be captured with smaller elements and larger elements should be used for flatter areas. The modern meshing tools, including the one in Simcenter 3D, can create such meshes easily. The user should define the geometrical tolerance and the interval for allowed element size, and the mesher creates a suitable mesh automatically.

As outlined above, said shape functions are piecewise-polynomial approximations of polynomial order/degree (p). Automatic p-adaptivity may benefit from robust adaptivity rules. A preferred embodiment of the invention applies an a-priori error estimator approach. The adaptivity rules may be based on the
1. element size,
2. the acoustic wavelength and
3. the required accuracy.

From these three input parameters the interpolation shape function order may be determined.

The a-priori error estimator may be modelled and trained from experiments across various configurations. These configurations may preferably be chosen to reflect the challenges of industrial applications, for instance, having a monopole source in a closed cavity where a high dynamic range of the field can be observed. Given the three inputs (a)-(c), the a-priori error estimator returns the shape function order. The a-priori error estimator may be modelled as a table of values, wherein said tabulated values are scanned, and the optimal shape function order is returned. Additionally, a shape and direction property may belong to the inputs of the determination of the shape function order respectively to the input of an adaptivity module providing the shape function order.

For the interpolation functions, Lobatto shape functions (also known as Integrated Legendre functions) have been the choice of preference. The invention supports high order shape functions, preferably e.g., implemented up to order six. Applying the standard accuracy rule, an order six element can accurately interpolate up to two wavelengths per element. Compared to the conventional requirements, wherein the rule of thumb regarding the meshing refinement is ‘six linear elements per wavelength’ the invention enables a rule like ‘up to half elements per wavelength’ which compresses the models very efficiently.

Lobatto shape functions are hierarchical and they are composed of nodal, edge and face functions. As it is shown in [9], they are beneficial for the system conditioning due to their orthogonality.

Edge-conformity rule is followed in BEMAO, such that the continuity of the field across elements with different orders is ensured. The highest order for the edge is always kept between two elements. For instance, if an element with order 2 and order 3 share an edge, the edge would have order 3, irrespective of the element it is attached to.

A preferred combination of the below features leads to a very powerful performance of the computer-implemented method according to the invention:
1. An accurate and robust integration kernel that can deal with the numerical singularities of BEM, especially for high order elements
   this may be very efficiently performed by using Sauter-Schwab quadrature rules when assembling the elements of said surface by recombing the shape functions obtaining a system matrix
2. An a-priori error estimator, that modifies the order of the interpolation shape functions on a per element and per frequency basis, while keeping the geometry shape functions constant
   this may be very efficiently performed by providing polynomial shape functions over each of said elements for mapping geometry and acoustic parameters to said elements, wherein for each surface element determining the order of said shape functions by an adaptivity module,
3. A Multipole Acceleration based procedure that accelerates the system assembly time, while controlling the error of the far field approximations robustly
   this may be very efficiently performed by the system matrix assembly process is accelerated by using Fast Multipole Approximations.

The Multipole Acceleration method has been developed and well-studied to accelerate the conventional BEM. Essentially, the fast multipole method allows a conversion from a direct point-to-point operation to a cluster-to-cluster operation, thus reducing the original BEM O(N²) complexity for the system assembly. As the system coefficient matrix is not formed explicitly, an iterative solver can be employed to improve the solving process by exploiting the low rank property of the system. The formulation of conventional FMM and main principles are briefly summarized as follows. Further details are available from [10].

As an example considering two clusters of points being randomly distributed in space, which can be considered as some sets of the integration points from a group of boundary elements, wherein x₀ and y₀ are the centers of the source cluster C₁ and the target cluster C₂ respectively. When C₁ and C₂ are well separated, one could convert a sequential evaluation from xⱼ to yₗ, to a fast multipole evaluation.

In mathematical perspective, the three dimensional Green's function in equation can be rewritten using Gegenbauer addition theorem and plane wave expansion form:

$$\frac{{e}^{ik ‖ {x}_{j} - {y}_{l} ‖}}{4 π ‖ {x}_{j} - {y}_{l} ‖} = \frac{{e}^{ik ‖ d + D ‖}}{4 π ‖ d + D ‖} = \frac{ik}{16 {π}^{2}} {\int }_{{S}^{2}} {e}^{ik ( {y}_{1} - {y}_{0} ) \cdot s} {M}_{L} ( s , D ) {e}^{ik ( {x}_{0} - {x}_{j} ) \cdot s} ds$$

The diagonal translation operator M_{L} is defined as

$${M}_{L} ( s , D ) = {\sum }_{l = 0}^{L - 1} ( 2 l + 1 ) {i}^{l} {{h}_{l}}^{( 1 )} ( kD ) {P}_{l} ( s \cdot \hat{D} )$$

Where d=(y₁−y₀)+(x₀−xⱼ), D=y₀−x₀, d=∥d∥, D=∥D∥, hₗ⁽¹⁾(·) is a spherical Hankel function of the first kind of order 1, Pₗ(·) is a Legendre polynomial. Normalized vectors are indicated by. s is the unit sphere given by s(θ, ϕ)=(sin θ cos ϕ, sin θ sin ϕ, cos θ). 0≤θ≤π, 0≤ϕ≤2π are polar angle and azimuthal angle in the spherical coordinate system.

The right-hand side of the above equation consists of three terms which corresponds to the three steps of multipole evaluation:
Upward pass: the contributions of all xⱼ is computed to x₀, which is the center of the source cluster C₁
Multipole translation: compute the multipole translation from source cluster's center x₀ to target cluster's center y₀ by the diagonal translation operator M_{L};
Downward pass: distribute the contribution from center y₀ to all yₗ in the cluster C₂.

The series representation of the translation operator M_{L} must be carefully truncated to avoid excessive error. With insufficient terms, the series is a poor approximation; but with too many terms, the divergent nature emerges. Considering the truncation need from numerical evaluation and the finite precision of the floating point numbers, this truncation number must be carefully chosen.

In the numerical implementation, the sum of l in the equation is truncated at l=L. A semi-empirical rule for the expansion length is given by as:

$$L = {kd}_{l} + p log ( {kd}_{l} + π )$$

where p specifies the required precision, dₗ is the maximum diameter of the clusters on the same level.

As described in the integral over the unit sphere surface S can be evaluated numerically, in the θ direction by using a Gauss-Legendre integration with L points and in the ϕ direction by using a trapezoidal rule with 2L-point:

$${\int }_{{S}^{2}} f ( s ) ds = {\int }_{- 1}^{1} {\int }_{0}^{2 π} f ( s ) d o \vert d ( cos ( θ ) ) \approx {\sum }_{i = 1}^{L} {\sum }_{j = 1}^{2 L} {ω}_{i} \frac{π}{L} f ( {s}_{i , j} )$$

with ωᵢ the weight of the Gauss-Legendre integration for the ith integration point in the θ-direction.

According to still another preferred embodiment of the invention said acoustic parameters and/or key figures calculated from said acoustic parameters or images illustrating said acoustic parameter fields are displayed to a user and/or provided to an iterative object design process for improving acoustic emission.

The invention further relates to a computer product arranged and configured to execute the steps of the computer-implemented method as explained herein and as defined by the claims.

The invention further relates to a computer-readable medium encoded with executable instructions, that when executed, cause the computer product according to claim 16 to carry out a method according to the invention.

The invention further relates to a system for determining acoustic parameters of an object's emission, the system comprising at least one processor being prepared by upload of computer-executable code to perform a method according to the invention.

### BRIEF DESCRIPTION OF THE DRAWINGS

Embodiments of the invention are now described, by way of example only, with reference to the accompanying drawings, of which:

FIG. 1 shows a typical example of application of the method or a system according to the invention,

FIG. 2 shows a comparison of the results of different methods to determine the sound emission including the method according to the invention,

FIG. 3 shows a flow diagram of a method according to the invention.

### DESCRIPTION OF THE DRAWINGS

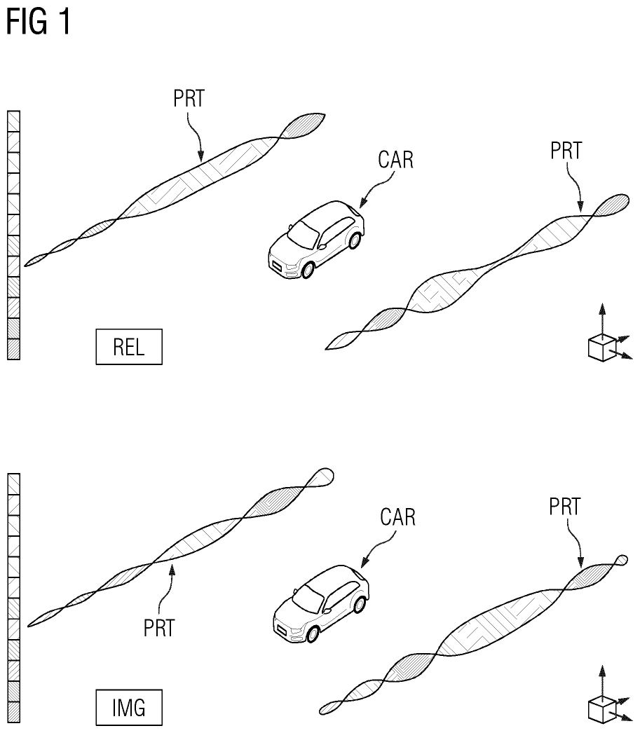

FIG. 1 shows an illustration of an acoustic pass by scenario of a car's CAR exhaust sound emission at a peak frequency of 81.96 Hz and a certain distance (7, 5 m) respectively on the right and left hand side of the car CAR. This is a typical example of application of the invention. The upper part REL of the illustration shows the real measurement of an acoustic parameter PRT—here the acoustic pressure—at a specific frequency and a certain distance and the lower part IMG of the illustration shows the result determined by the method according to the invention.

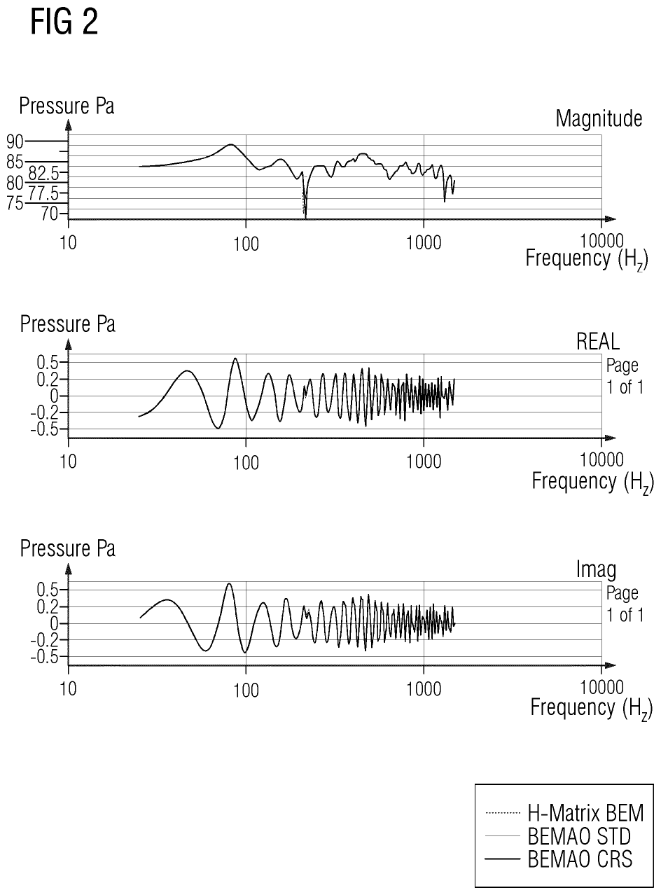

FIG. 2 demonstrates the accuracy of the method and confirms that BEMAO gives very accurate results even for highly non-homogenous meshes. BEMAO results are perfectly matching with H-Matrix BEM. BEMAO results have a good match for standard meshing (STD) and coarse meshing (CRS).

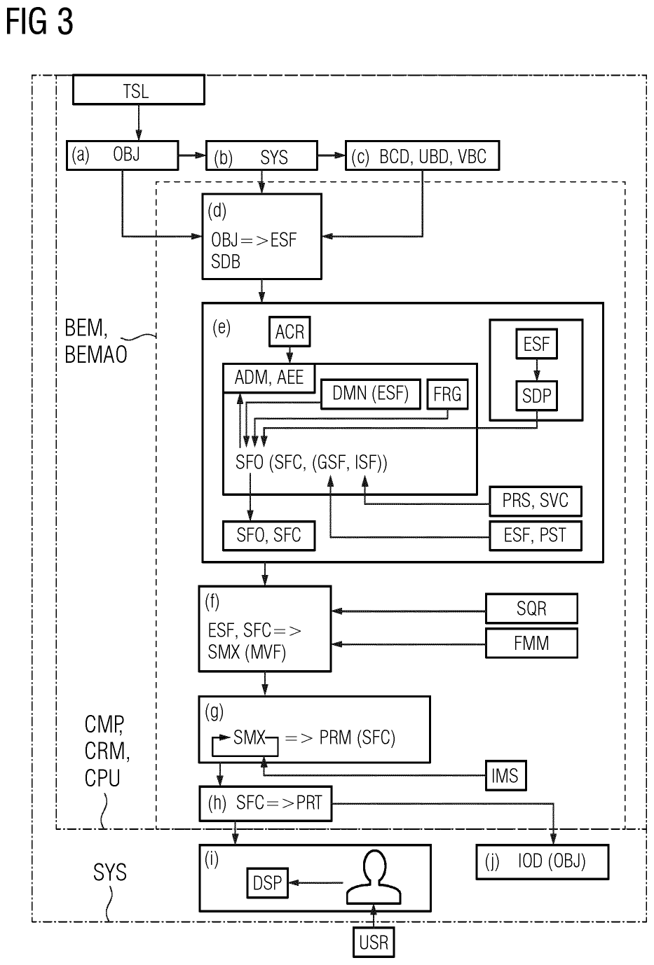

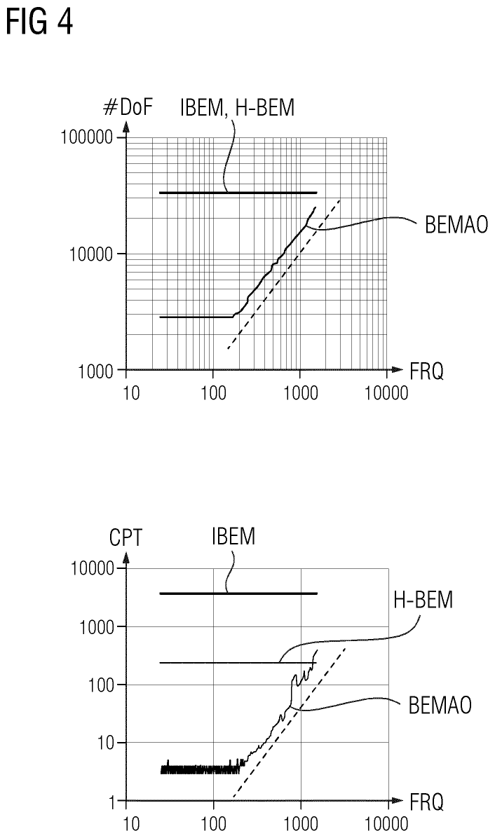

FIG. 3 shows a simplified flow diagram illustrating a computer-implemented method for determining acoustic parameters PRT of an object's OBJ emission and/or scattering within a predetermined frequency range FRG according to an embodiment of the invention.

As a first step (a) the method defines said object OBJ which is contained in a system SYS defined during step (b). Said object OBJ may be provided by the object's OBJ surface SFC geometry in particular by providing an object's surface tessellation TSL. In a third step (c) boundary conditions BCD for said system SYS including defining a sound source SDS are provided. Said boundary conditions BCD defined may include boundary conditions BCD relating to said object OBJ and/or include boundary conditions BCD referring to limits of said system SYS and/or said system SYS at least partially being defined as an unbounded domain UBD. Further said boundary conditions BCD include vibration characteristics VBC of said sound source SDS resulting from excitation of said object OBJ applied in at least one excitation frequency FEC.

Subsequently the Boundary Element Method BEM is applied to the system SYS.

The BEM starts (step (d)) with splitting said object's OBJ surface into surface elements ESF and assigning said boundary conditions BCD to said surface elements ESF. Said sound source SDS and/or said object's OBJ surface may be split in surface elements ESF by applying a triangular or quadrilateral or hybrid mesh of surface elements ESF, in particular a mesh comprising elements of at least one of the types Tria3, Tria6, Quad4, Quad8.

The Boundary Element Method BEM automatically adapts to the problem by providing polynomial shape functions SFC over each of said elements ESF for mapping geometry and acoustic parameters to said elements ESF, wherein for each surface element ESF determining the order SFO of said shape functions SFC by an adaptivity module ADM.

During the next step (e) the order SFO of said shape functions SFC is defined starting with defining at least one accuracy ACR requirement. Said shape functions SFC may comprise:
geometry shape functions GSF mapping quadrature points of said elements ESF to a surface position PST and
interpolation shape functions ISF mapping quadrature points of said elements ESF to pressure PRS and/or sound velocity SVC based on input frequency FRQ.

Said shape functions SFC may preferably be polynomial shape functions SFC for approximating parameters PRT and may preferably be provided non-isoparametric.

Said adaptivity module ADM receives next to the accuracy ACR requirement as an input at least the surface element's ESF dimensions DMN, and the frequency range FRG. Determining the order SFO of said shape functions SFC may further comprise to determine for each of said surface elements ESF a shape and direction property SDP. Said property SDP comprises data about dimensional relations including directional information, providing said shape and direction property SDP as additional input.

Said adaptivity module ADM may determine the shape function order SFO by iteratively applying an a-priori error estimation AEE from the input received. This may be repeated until the error estimate ERA corresponds to the required accuracy ACR.

The adaptivity module ADM preferably determines the order SFO of said shape functions SFC for each surface element ESF.

Said adaptivity module ADM finally returns as an output said shape function order SFO.

With the shape function orders SFO for each surface element ESF step (f) performs an assembly of the elements ESF of said surface by recombing the shape functions SFC obtaining a system matrix SMX. The system matrix SMX assembly process is accelerated by using Fast Multipole Approximations FMM, wherein the Fast Multipole Approximations FMM are multiplied with each other and form the system matrix SMX. The assembly (step f) is performed by using Sauter-Schwab quadrature rules SQR.

Subsequently said Fast Multipole Approximations FMM are stored in a matrix-vector format MVF and this system matrix SMX is solved with an iterative matrix solver IMS (step g).

After solving said system matrix SMX said acoustic parameters PRT are determined from said shape functions SFC in step (h).

These acoustic parameters PRT and/or key figures calculated from said acoustic parameters PRT or images illustrating said acoustic parameter fields may be displayed to a user USR by a display device DSP and/or may be provided said to an iterative object design process IOD for e.g., designing, improving, reducing, or optimizing acoustic emission.

FIG. 3 further shows a computer product CMP or computer program product arranged and configured to execute the steps of the computer-implemented method as described herein. Such computer product CMP may be stored on a computer-readable medium encoded with executable instructions, that when executed, cause the computer CPU or computer product CMP to carry out said method according to the invention. FIG. 3 also shows a system SYS for determining acoustic parameters of an object's emission This system SYS comprises at least one processor CPU being prepared by upload of computer-executable code to perform a method according to the invention.

FIG. 4 shows a performance analysis demonstrating how the method automatically adapts itself based on the frequency/Hz FRQ. The left figure shows the evolution of the number of degrees of freedom for each method. For conventional Indirect Boundary Element Method IBEM and conventional hierarchical matrix assembly, often called H-Matrix BEM H-BEM, the model size does not change, while the invention BEMAO finds the optimum discretization per frequency. The right figure shows the resulting CPU times/s CPT from these models, demonstrating how efficient BEMAO becomes in a frequency sweep scenario.

Comparing the computational times between the three methods IBEM, H-Matrix BEM and the invention—named BEMAO—may illustrate the advantages of the invention. The below table illustrates an example scenario of a pass-by noise from a car. 200 frequency calculations from 25 to 1500 Hz have been done with a logarithmic distribution. BEMAO shows its impressive computational efficiency as compared to classical IBEM method and even out-performing the H-Matrix BEM.

| | | H-Matrix | | | | |
|---|---|---|---|---|---|---|
| | IBEM | BEM | Invention, BEMAO | | | |
| Mic. | 1D: 4002 nodes | | 1D: 4002 nodes | | | |
| mesh | | | | | | |
| Fluid | 65998 TRIA3 | | 3226 TRIA6 | | | |
| mesh | elements, 33067 nodes | | elements, 6506 nodes | | | |
| CPU | 4 h | 8 h | Coarse | Coarse | Standard | Standard |
| time | | | 1 h | AA | 4 h | AA |
| | | | | 0.5 h | | 1.5 h |

1. Computer-implemented method for determining acoustic parameters (PRT) of an object's (OBJ) emission and/or scattering within a predetermined frequency range (FRG), comprising the steps:
(a) Defining said object (OBJ),
(b) Defining a system (SYS) containing said object (OBJ),
(c) Providing boundary conditions (BCD) for said system (SYS) including defining a sound source (SDS),
(d) Applying Boundary Element Method (BEM) to said system (SYS) comprising splitting said object's (OBJ) surface into surface elements (ESF) and assigning said boundary conditions (BCD) to said surface elements (ESF),
characterized by the Boundary Element Method (BEM) including:
(e) Providing polynomial shape functions (SFC) over each of said elements (ESF) for mapping geometry and acoustic parameters to said elements (ESF), wherein for each surface element (ESF) determining the order (SFO) of said shape functions (SFC) by an adaptivity module (ADM),
(f) Assembling the elements (ESF) of said surface by recombing the shape functions (SFC) obtaining a system matrix (SMX),
(g) Solving said system matrix (SMX),
(h) Determining said acoustic parameters (PRT) from said shape functions (SFC).

2. A method according to claim 1, comprising:
Defining at least one accuracy (ACR) requirement,
wherein in step (e) said adaptivity module (ADM) receiving as an input at least:
said accuracy requirement (ACR)
the surface element's (ESF) dimensions (DMN), and
the frequency range (FRG), and
returning as an output said shape function order (SFO).

3. A method according to claim 2, wherein determining the order (SFO) of said shape functions (SFC) is comprising:
determining for said surface elements (ESF) a shape and direction property (SDP), wherein said property (SDP) comprises data about dimensional relations including directional information,
providing said shape and direction property (SDP) as additional input to step (e).

4. A method according to at least one of the preceding claims 1-3, wherein said boundary conditions (BCD) defined in step (c) include boundary conditions (BCD) relating to said object (OBJ) and/or include boundary conditions (BCD) referring to limits of said system (SYS) and/or said system (SYS) at least partially being defined as an unbounded domain (UBD).

5. A method according to claim 4, wherein boundary conditions (BCD) relating to said object (OBJ) include vibration characteristics (VBC) of said sound source (SDS) resulting from excitation applied in at least one excitation frequency (FEC).

6. A method according to at least one of the preceding claims 1-5, wherein step (a) is performed by providing the object's (OBJ) surface (SFC) geometry in particular by providing an object's surface tessellation (TSL).

7. A method according to at least one of the preceding claims 1-6, wherein step (f) is performed by using Sauter-Schwab quadrature rules (SQR).

8. A method according to at least one of the preceding claims 1-7, wherein in step (e) said sound source (SDS) is split in surface elements (ESF) by applying a triangular or quadrilateral or hybrid mesh of surface elements (ESF), in particular a mesh comprising elements of at least one of the types Tria3, Tria6, Quad4, Quad8.

9. A method according to at least one of the preceding claims 1-8, wherein in step (e) said shape functions (SFC) comprise:
geometry shape functions (GSF) mapping quadrature points of said elements (ESF) to a surface position (PST) and
interpolation shape functions (ISF) mapping quadrature points of said elements (ESF) to at least one acoustic parameter (PRT) based on input frequency (FRQ).

10. A method according to at least the preceding claim 9, wherein in step (e) said polynomial shape functions (SFC) for approximating parameters (PRT) are provided non-isoparametric.

11. A method according to at least the preceding claim 2, wherein said adaptivity module (ADM) determines the order (SFO) of said shape functions (SFC) for each surface element (ESF) by iteratively applying an a-priori error estimation (AEE) from
the surface element's dimensions, and
the frequency range, and
the shape function order
until the error estimate (ERA) corresponds to the required accuracy (ACR).

12. A method according to at least one of the preceding claims 1-11, wherein in step (f), the system matrix (SMX) assembly process is accelerated by using Fast Multipole Approximations (FMM).

13. A method according to at least the preceding claim 12, wherein the Fast Multipole Approximations (FMM) are multiplied with each other and form the system matrix (SMX).

14. A method according to at least the preceding claim 12, comprising
storing of said Fast Multipole Approximations (FMM) in a matrix-vector format (MVF),
executing step (g) with an iterative matrix solver (IMS).

15. A method according to at least one of the preceding claims 1-14, comprising
(i) displaying said acoustic parameters (PRT) and/or key figures calculated from said acoustic parameters (PRT) or images illustrating said acoustic parameter fields to a user (USR) and/or
(j) providing said acoustic parameters to an iterative object design process (IOD) for designing acoustic emission.

16. Computer product (CMP) arranged and configured to execute the steps of the computer-implemented method according to any one of the preceding claims 1 to 15.

17. A computer-readable medium (CRM) encoded with executable instructions, that when executed, cause the computer product according to claim 16 to carry out a method according to any one of claims 1 to 15.

18. System (SYS) for determining acoustic parameters of an object's emission, the system (SYS) comprising at least one processor (CPU) being prepared by upload of computer-executable code to perform a method according to at least one of the preceding claims 1-14.
